(19) United States
(12) Patent Application Publication
(10) Pub. No.: US 2015/0118011 A1
(43) Pub. Date: Apr. 30, 2015

(54) TRAY STACKER SYSTEM AND METHOD OF OPERATION THEREOF

(71) Applicant: DATA I/O CORPORATION, Redmond, WA (US)

(72) Inventor: Rossen Atanassov Rachkov, Kenmore, WA (US)

(73) Assignee: DATA I/O CORPORATION, Redmond, WA (US)

(21) Appl. No.: 14/067,473

(22) Filed: Oct. 30, 2013

(51) Int. Cl. B65G 57/16

(52) U.S. Cl. CPC B65G 57/16
USPC 414/802

(57) ABSTRACT

A system and method of operation of a tray stacker system includes: an input stacker for providing a source tray having a plurality of electrical components; an unload receptacle for receiving the source tray from the input stacker; an output stacker for providing the target tray empty of the electrical components; a load receptacle for receiving the component tray empty of the electrical components from the output stacker; and wherein: the unload receptacle is for receiving a source replacement tray from the input stacker, the source replacement tray having a plurality of the electrical components, and the load receptacle is for swapping the target replacement tray in the output stacker with the target tray in the load receptacle, the target tray having a plurality of the electrical components.

### TECHNICAL FIELD

The present invention relates generally to a manufacturing system for electronic products, and more particularly to a tray stacker system.

### BACKGROUND ART

Certain operations of electronic circuit board assembly are performed away from the main production assembly lines. While various feeder machines and robotic handling systems populate electronic circuit boards with integrated circuits, the operations related to processing integrated circuits, such as programming, testing, calibration, and measurement are generally performed in separate areas on separate equipment rather than being integrated into the main production assembly lines.

For example, in the programming of programmable devices such as Flash memories, electrically erasable programmable read only memories (EEPROM), programmable logic devices (PLDs), field programmable gate arrays (FPGAs), and microcontrollers incorporating non-volatile memory elements separate programming equipment is used which is often located in a separate area from the circuit board assembly lines.

There is a need for a system and system sub-assemblies that enable just-in time programming of multiple programmable devices. For example, earlier systems use tape-on-reel lines that rely on carrier tapes with micro devices such as programmable devices placed at uniform distances on the tape. The programmable devices on the tape are protected by a cover tape that is removed just prior to handling the micro device and can be delivered to a manufacturing system.

Thus, a need still remains for a system and system sub-assemblies that enable just-in time programming of multiple programmable devices within a manufacturing line. In view of the lack of operational efficiency in the programming and packaging of programmable devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a tray stacker system including: moving a source tray into an unload receptacle from an input stacker, the source tray for providing a plurality of electrical components; moving a target tray into a load receptacle from an output stacker, the target tray, the target tray for receiving the electrical components from the component tray in the unload receptacle and the target tray empty of the electrical components; transferring the electrical components from the source tray to the target tray; moving a source replacement tray from the input stacker to the unload receptacle for replacing the source tray empty of the electrical components and moving the source tray to the output stacker; and swapping a target replacement tray in the output stacker with the target tray in the load receptacle, the target tray having a plurality of the electrical components.

In addition, the present invention provides a tray stacker system including: an input stacker for providing a source tray having a plurality of electrical components; an unload receptacle for receiving the source tray from the input stacker; an output stacker for providing the target tray empty of the electrical components; a load receptacle for receiving the component tray empty of the electrical components from the output stacker; and wherein: the unload receptacle is for receiving a source replacement tray from the input stacker, the source replacement tray having a plurality of the electrical components, and the load receptacle is for swapping the target replacement tray in the output stacker with the target tray in the load receptacle, the target tray having a plurality of the electrical components.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary view of a tray stacker system in an embodiment of the present invention.

FIG. 2 is an exemplary isometric view of the tray stacker.

FIG. 3 is a top view of the tray stacker.

FIG. 4 is an exemplary isometric view of a tray stacker in a second embodiment of the present invention.

FIG. 5 is an exemplary isometric view of a portion of the tray stacker with clamp cylinders.

FIG. 6 is an exemplary isometric view of a portion of the tray stacker with the tray positioning cylinders and the tray adjust fingers.

FIG. 7 is an exemplary side view of the tray stacker.

FIG. 8 is an exploded view of the shuttle.

FIG. 9 is a first exemplary isometric view of the shuttle.

FIG. 10 is a second exemplary isometric view of the shuttle.

FIG. 11 is an exemplary side view of the shuttle.

FIG. 12 is an isometric view of the component tray.

FIG. 13 is a control flow of the tray stacker system.

FIG. 14 is a flow chart of a method of operation of the tray stacker system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known structural element, configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

The term “on” means that there is direct contact between elements. The term “directly on” means that there is direct contact between one element and another element without an intervening element. Terms such as first or second are used for identification purposes only and do not indicate any order, priority, importance, or precedence.

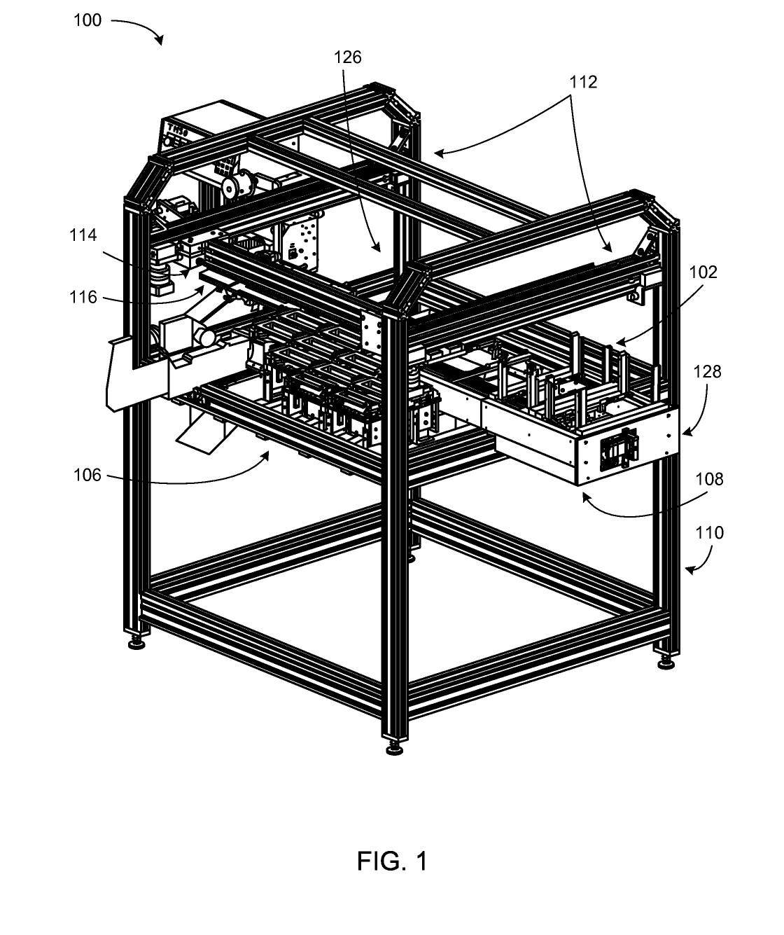

Referring now to FIG. 1, therein is shown an exemplary view of a tray stacker system 100 in an embodiment of the present invention. The tray stacker system 100 can include a tray stacker 102 coupled to a host controller 108 of FIG. 1 and a programming station 106.

The tray stacker 102 is a mechanical system for manipulating and positioning trays of electrical components. The tray stacker 102 is attached to a mounting frame 110.

The mounting frame 110 is a structure for attaching manufacturing elements. The mounting frame 110 can be formed using structural elements fastened at connection points between the structural elements or welded together. The structural elements can include metal bars, composite bars, plastic bars, or a combination thereof.

The mounting frame 110 can include a host machine robot 114 for manipulating electrical components. The host machine robot 114 can transfer electrical components from the tray stacker 102 to the programming station 106.

The host machine robot 114 can include horizontal rails 112 coupled to a horizontal arm 116 for positioning vertical manipulator (not shown) having a component picker (not shown) between the tray stacker 102 and the programming station 106.

An external controller (not shown) can direct the motion and position of the horizontal arm 116 and the component picker to move electrical components (not shown) from the tray stacker 102 to the programming station 106. The electrical components can include memory chips, Field Programmable Gate Arrays, Flash memory, programmable read only memory, or a combination thereof.

The electrical components can be programmed in the programming station 106. The programming station 106 is a device for configuring and programming electrical components. For example, the programming station 106 can include a flash memory programmer, a FPGA programmer, an EEPROM burner, or a combination thereof. The external controller can direct the motion and position of the horizontal arm 116 and the component picker to return the programmed electrical components to the tray stacker 102.

The tray stacker 102 is a rectangular structure having a stacker front end 126 and a stacker back end 128. The stacker front end 126 is within the mounting frame 110 and below the horizontal rails 112. The stacker back end 128 must extend outside of the mounting frame 110.

For expository purposes, the term “horizontal” as used herein is defined as a plane parallel to the horizontal rails 112 and the horizontal arm 116 of the host machine robot 114, regardless of orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

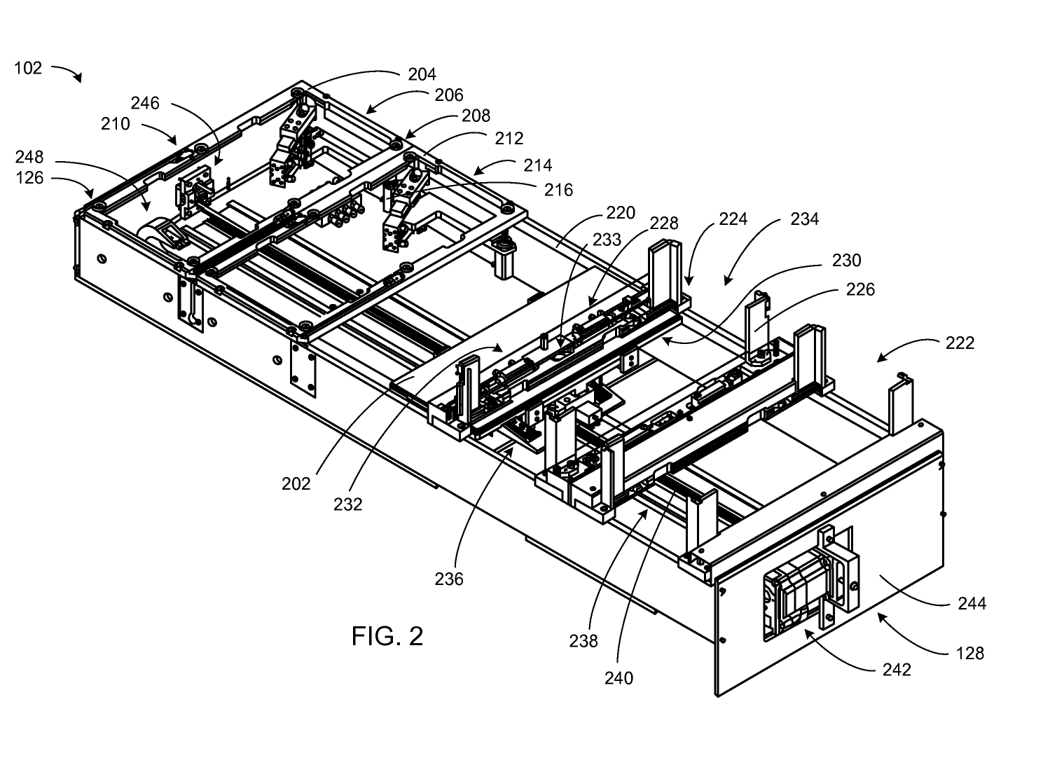

Referring now to FIG. 2, therein is shown an exemplary isometric view of the tray stacker 102. The tray stacker 102 is a mechanical structure for manipulating and positioning component trays 202 having electrical components (not shown) positioned thereon.

The component trays 202 are a flat rectangular structure for holding electrical components. The component trays 202, such as a target tray or a source tray, can be used to organize the electrical components that are blank or programmed. The source tray is one of the component trays 202 having electrical components. The target tray is one of the component trays 202 acting as a destination for the electrical components. The target tray can initially be empty and then loaded with the electrical components.

The tray stacker 102 can include a load receptacle 206 located at the stacker front end 126 of the tray stacker 102. The load receptacle 206 is a mechanical structure for retaining one of the component trays 202 for receiving programmed electrical components. The load receptacle 206 can be controlled by the host controller 108 of FIG. 1.

The load receptacle 206 can include a blank parts tray frame 204. The blank parts tray frame 204 is a four sided structure sized to allow one of the component trays 202 to pass vertically through the central opening of the blank parts tray frame 204. In another example, the blank parts tray frame 204 can be a two-piece structure.

The load receptacle 206 can include hard stop bumpers 208 for holding the component trays 202. The hard stop bumpers 208 can be attached to the blank parts tray frame 204. The hard stop bumpers 208 are structural elements used to hold and retain one of the component trays 202. For example the hard stop bumpers 208 can be rubber disks, washers, plugs, machined features in the frame, or a combination thereof.

The blank parts tray frame 204 can optionally include a receptacle tray sensor 210, which is an optical sensor for detecting the presence of one of the component trays 202. For example, the receptacle tray sensor 210 can be a through beam sensor to detect the component trays 202 within the horizontal plane of the blank parts tray frame 204.

In another example, the receptacle tray sensor 210 can bounce an optical signal off of a reflector on the opposite side of the blank parts tray frame 204. If the optical signal is interrupted by one of the component trays 202, then the receptacle tray sensor 210 can indicate the presence of one of the component trays 202.

The tray stacker 102 can include an unload receptacle 214 located between the load receptacle 206 and the stacker back end 128 of the tray stacker 102. The unload receptacle 214 is a mechanism for holding one of the component trays 202 having blank electrical components.

The unload receptacle 214 can include a programmed parts tray frame 212. The programmed parts tray frame 212 is positioned next to the blank parts tray frame 204. The programmed parts tray frame 212 is a rectangular structure sized to allow one of the component trays 202 to pass vertically through the central opening of the programmed parts tray frame 212. In another example, the programmed parts tray frame 212 can be a two-piece structure.

The unload receptacle 214 can include the hard stop bumpers 208 for holding the component trays 202. The hard stop bumpers 208 can be attached to the programmed parts tray frame 212.

The programmed parts tray frame 212 can include the receptacle tray sensor 210 for detecting the presence of one of the component trays 202 within the horizontal plane of the programmed parts tray frame 212. For example, the receptacle tray sensor 210 can bounce an optical signal off of a reflector on the opposite side of the programmed parts tray frame 212. If the optical signal is interrupted by one of the component trays 202, then the receptacle tray sensor 210 can detect the presence of one of the component trays 202.

The tray stacker 102 can include a tray positioning cylinder 216 for adjusting the position of one of the component trays 202 within the blank parts tray frame 204 or the programmed parts tray frame 212. The tray positioning cylinder 216 can push one of the component trays 202 diagonally against two opposing reference planes, as exemplified by the sides of the blank parts tray frame 204 or the programmed parts tray frame 212.

The tray stacker 102 can include a guide tape 220 attached to the lateral sides of the tray stacker 102 for providing a travel path for the component trays 202 and for providing electrical conductivity to dissipate a static electric charge on the component trays 202. The guide tape 220 can form a conductive path between the component trays 202 and a system ground for dissipating electrical charge. For example, the guide tape 220 can be an Ultra High Molecular Weight (UHMW) static dissipative guide tape with a self-adhesive back.

The tray stacker 102 can include an input stacker 222, which is a mechanism for holding a plurality of the component trays 202. The input stacker 222 can be used to hold the component trays 202 having blank electrical components (not shown). For example, the input stacker 222 can be positioned at the stacker back end 128 of the tray stacker 102.

The input stacker 222 can include stacker units 224, which are mechanisms for retaining a plurality of the component trays 202 in a vertical configuration. Two of the stacker units 224 can receive one of the component trays 202 and add component trays 202 to a vertical stack of the component trays 202 in the input stacker 222. For example, the stacker units 224 can include mirror configuration units such that two of the stacker units 224 can face one another to hold a stack of the component trays 202. In another example, the component trays 202 can connect directly to the next higher one of the component trays 202 to form a stack without any additional elements.

The stacker units 224 are positioned to form an opening between two of the stacker units 224. The opening between two of the stacker units 224 is sized to allow the component trays 202 to be lifted vertically from below and up into the input stacker 222.

Each of the stacker units 224 includes stack guides 226 positioned at locations corresponding to the corners of the component trays 202. The stack guides are vertical structures intended to restrain a corner of one of the component trays 202 while supporting the stack of the component trays 202. Two of the stacker units 224 having four of the stack guides 226 can be used to hold the vertical stack of the component trays 202.

Although the stacker units 224 are described as having two of the stack guides 226, it is understood that other configurations are possible. The stacker units 224 can include two or more of the stack guides 226 for supporting the component trays 202.

Each of the stacker units 224 includes stacker tray locks 228, which are mechanisms for attaching to the bottommost of the component trays 202 in the input stacker 222. For example, each of the stacker units 224 can include two of the stacker tray locks 228 for attaching to the component trays 202. The stacker tray locks 228 can include a lock arm 230 and a stacker lock cylinder 232.

The stacker tray locks 228 can include the lock arm 230 that can be extended from one of the stacker units 224 to engage with one of the component trays 202. The lock arm 230 is a structural member for engaging with the component trays 202. The lock arm 230 can be extended by the stacker lock cylinders 232, such as a pneumatic cylinder. The stacker lock cylinders 232 can be controlled by the host controller 108. The stacker lock cylinders 232 are mechanisms having extensible elements.

The stacker units 224 can include a stacker tray sensor 233, which is a device for detecting the presence of one of the component trays 202. The stacker tray sensor 233 is positioned in the middle of the stacker units 224. For example, the stacker tray sensor 233 can be a through beam sensor to detect the component trays 202 within bottommost position of the input stacker 222.

In another example, the stacker tray sensor 233 can bounce an optical signal off of a reflector on the opposite side of the input stacker 222. If the optical signal is interrupted by one of the component trays 202, then the stacker tray sensor 233 can indicate the presence of one of the component trays 202.

The tray stacker can include an output stacker 234, which is a mechanism for holding a plurality of the component trays 202. The output stacker 234 can be used to hold the component trays 202 having programmed electrical components (not shown). The output stacker 234 can be positioned between the input stacker 222 and the programmed parts tray frame 212.

The output stacker 234 has generally the same configuration as the input stacker 222. The output stacker 234 includes two of the stacker units 224 positioned to allow the vertical entry of one of the component trays 202.

Each of the stacker units 224 includes two of the stack guides 226 to support the stack of the component trays 202. Each of the stacker units 224 includes two of the stacker tray locks 228 for attaching to one of the component trays 202 with the lock arm 230.

The output stacker 234 can include the stacker tray sensor 233 for detecting the presence of one of the component trays 202 in the bottommost position of the output stacker 234.

The tray stacker 102 can include a shuttle 236, which is a mechanical component for moving the component trays 202 within the tray stacker 102. The shuttle 236 can move from the stacker front end 126 to the stacker back end 128 of the tray stacker 102 while carrying one of the component trays 202. For example, the shuttle 236 can move one of the component trays 202 from the programmed parts tray frame 212 to the output stacker 234. The shuttle 236 can move the component trays 202 horizontally and vertically.

The tray stacker 102 can include a shuttle linear guide 238, which is a mechanical guide for constraining the motion of the shuttle 236 within the tray stacker 102. The shuttle linear guide 238 can be positioned on the bottom of the interior of the tray stacker 102. The shuttle linear guide 238 can extend from the stacker front end 126 of the tray stacker 102 to the stacker back end 128 of the tray stacker 102. The shuttle linear guide 238 can include a variety of configurations. For example, the shuttle linear guide 238 can include two guides in a parallel configuration.

The shuttle linear guide 238 can be configured in a variety of ways. For example, the shuttle linear guide 238 can include grooved sides to engage the shuttle 236. In another example, the shuttle linear guide 238 can include linear ball bearings, roller bearing guides, or a combination thereof. The shuttle 236 is coupled to the shuttle linear guide 238. The shuttle 236 can move backward and forward along the length of the shuttle linear guide 238.

The tray stacker 102 can include a shuttle drive belt 240. The shuttle drive belt 240 is central to the shuttle linear guide 238 and can be located between two of the shuttle linear guide 238. The shuttle drive belt 240 is a band of material used for moving the shuttle 236. For example, the shuttle drive belt 240 can be formed from polymer, plastic, woven composite, chain, fabric, a toothed belt, or a combination thereof. The shuttle drive belt 240 is attached to the shuttle 236.

The shuttle drive belt 240 is manipulated and moved using a shuttle drive motor 242. The shuttle drive motor 242 is an electromechanical component for driving the shuttle drive belt 240 and moving the shuttle 236. The shuttle drive motor 242 is controlled by the host controller 108 and is used to position the shuttle 236 as necessary.

The tray stacker 102 can include a rear panel 244, which is a structural element covering the stacker back end 128 of the tray stacker 102. The rear panel 244 can include an opening for attaching the shuttle drive motor 242 to the tray stacker 102.

The tray stacker 102 can include a shuttle belt tensioner 246 attached to the rear panel 244. The shuttle belt tensioner 246 is a mechanical component for maintaining tension on the shuttle drive belt 240 to prevent the shuttle drive belt 240 from sagging, deforming, or a combination thereof.

The tray stacker 102 can include an e-chain 248 for holding cables, connectors, and pneumatic lines for the shuttle 236. The e-chain 248 is a flexible retaining structure that can move in coordination with the shuttle 236 to allow the cables, connectors, and lines within the e-chain 248 to be connected to the shuttle 236. For example, as the shuttle 236 moves, the e-chain 248 can move in a synchronous fashion to prevent the cables, connectors, and lines from being pulled from the shuttle 236.

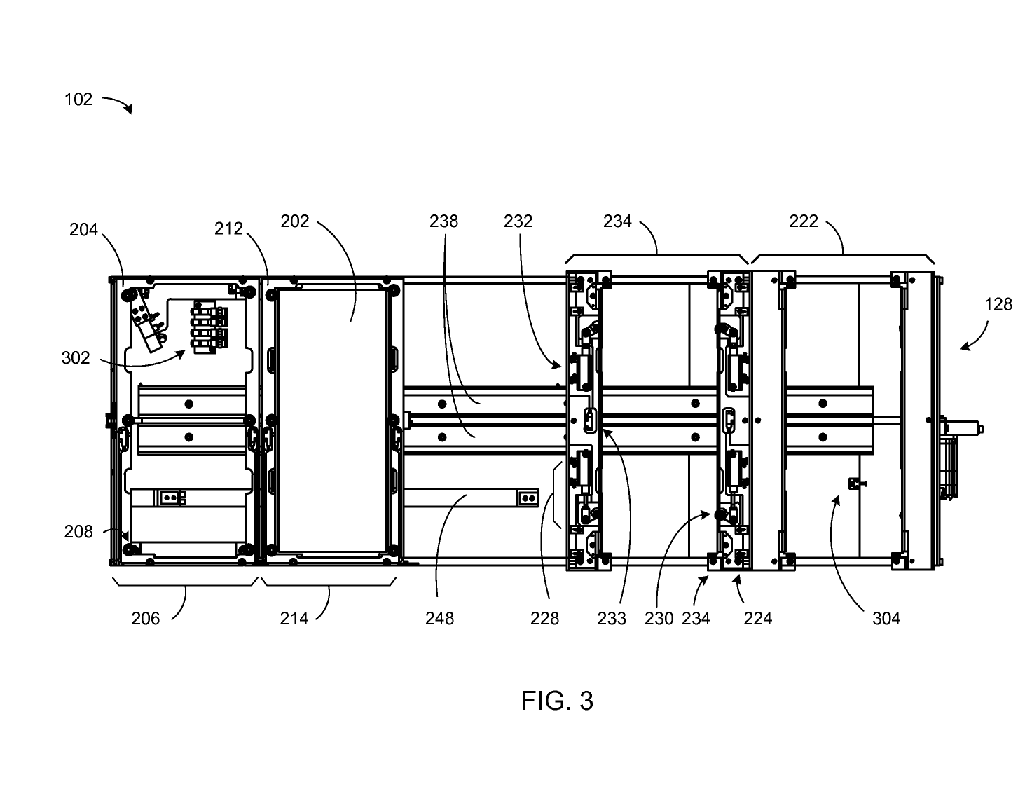

Referring now to FIG. 3, therein is shown a top view of the tray stacker 102. The tray stacker 102 can move the component trays 202 along the shuttle linear guide 238.

The tray stacker 102 can include the load receptacle 206, the unload receptacle 214, the output stacker 234, and the input stacker 222. The tray stacker 102 can move one of the component trays 202 having blank programmable electrical components (not shown) from the input stacker 222 to the unload receptacle 214.

The tray stacker 102 can move one of the component trays 202 having programmed electrical components (not shown) from the load receptacle 206 to the output stacker 234. The tray stacker 102 can include the stacker tray sensor 233 for detecting one of the component trays 202.

The tray stacker 102 can include an air distribution manifold 302 for providing air pressure to drive pneumatic components. The air distribution manifold 302 can provide attachment points for one or more pressurized air lines. For example, the air distribution manifold 302 can include four air lines.

The air distribution manifold 302 can have a variety of configurations and can be positioned in a variety of location on the tray stacker 102. In an illustrative example, the air distribution manifold 302 can be located inside the host controller 108.

The tray stacker 102 can include the blank parts tray frame 204 located at the front of the tray stacker 102. The blank parts tray frame 204 can include the hard stop bumpers 208 positioned to hold the component trays 202.

The tray stacker 102 can include the programmed parts tray frame 212 positioned between the blank parts tray frame 204 and the stacker back end 128. The programmed parts tray frame 212 includes the hard stop bumpers positioned to align the component trays 202.

The tray stacker 102 can include the component trays 202. The component trays 202 can be loaded with blank electrical components (not shown), programmed electrical components (not shown), or a combination thereof. For example, the component trays 202 can conform to the Joint Electron Devices Engineering Council (JEDEC) specification for trays for holding electrical components.

The tray stacker 102 can include the input stacker 222 having two of the stacker units 224. Each of the stacker units 224 can include two of the stacker lock cylinders 232 for holding the component trays 202 in place.

The tray stacker can include the output stacker 234 having two of the stacker units 224. Each of the stacker units can include two of the stacker lock cylinders 232 for holding the component trays 202 in place.

Each of the stacker units 224 can include the stacker lock mechanism 228. The stacker lock mechanism 228 can include the stacker lock cylinders 232 and the lock arm 230.

When the stacker lock cylinders 232 are not engaged, the lock arm 230 is not extended and the component trays 202 can move freely through the opening between the two of the stacker units 224. When the stacker lock cylinders 232 are engaged, the lock arm 230 is extended and can engage the component trays 202 for holding the component trays 202 in place.

The tray stacker 102 can include a shuttle home sensor 304, which is a device for detecting the home position of the shuttle 236 of FIG. 2. The shuttle home sensor 304 can be configured in a variety of ways and located anywhere along the shuttle path. For example, the shuttle home sensor 304 is positioned below and between the stacker units 224 of the input stacker 222.

The tray stacker 102 can include the e-chain 248. The e-chain 248 can be configured in a variety of ways. For example, the e-chain 248 can be positioned between the shuttle drive belt 240 of FIG. 2 and the side of the tray stacker 102 on the side of the tray stacker 102 opposite of the air distribution manifold 302. In another example, the e-chain 248 can be on the same side as the air distribution manifold 302.

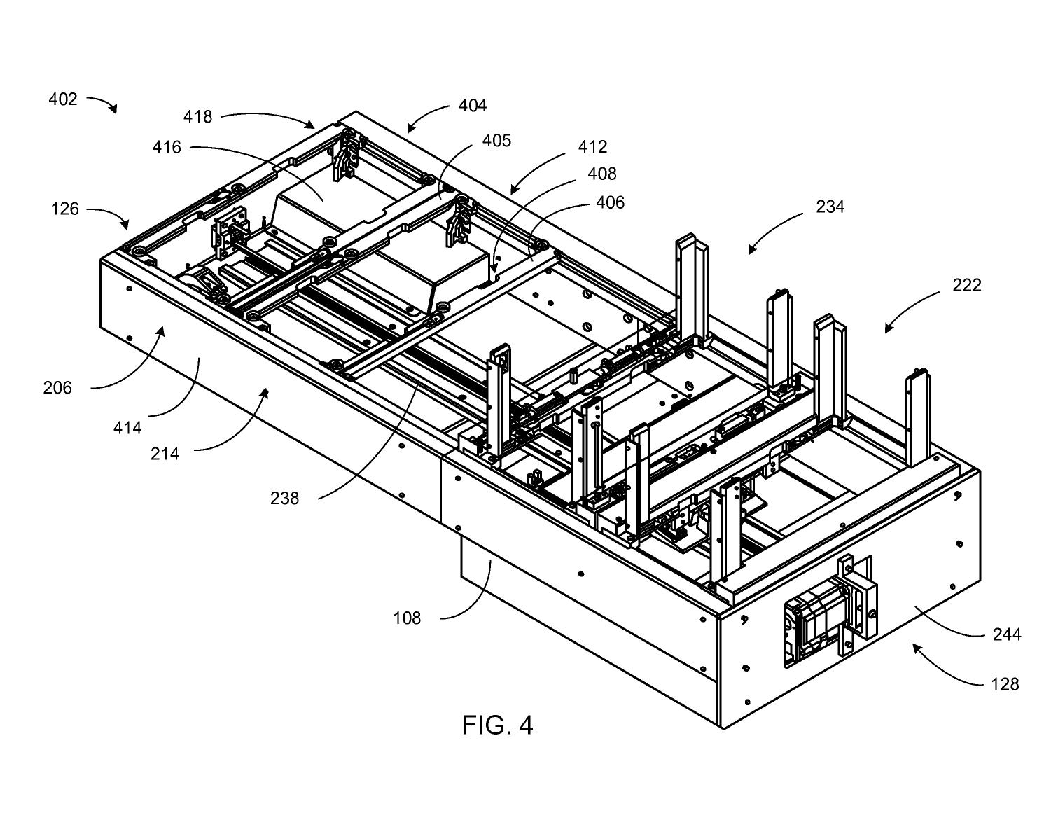

Referring now to FIG. 4, therein is shown an exemplary isometric view of a tray stacker 402 in a second embodiment of the present invention. The tray stacker 402 is an electromechanical mechanism for manipulating and positioning the component trays 202 of FIG. 2. The tray stacker 402 has similar components to the tray stacker 102 of FIG. 2 and similar elements have similar names.

The tray stacker 402 can include the load receptacle 206 for holding the component trays 202. The load receptacle 206 is a structure for receiving and holding one of the component trays 202 having blank electrical components. The load receptacle 206 can include a blank parts tray frame 404.

The blank parts tray frame 404 can include a left tray frame bar 405 and a right tray frame bar 406. The left tray frame bar 405 and the right tray frame bar 406 are mechanical structures for holding one of the component trays 202.

The left tray frame bar 405 and the right tray frame bar 406 can include three of the hard stop bumpers 208 of FIG. 2 for holding one of the component trays 202. The hard stop bumpers 208 are bumpers and the component trays 202 can be pressed against the hard stop bumpers 208 to hold the component trays 202 in place.

The left tray frame bar 405 and the right tray frame bar 406 can include bar notches 408, which are openings in the bars to accommodate the shuttle mechanisms holding the component trays 202. The left tray frame bar 405 and the right tray frame bar 406 can be similar structures.

The left tray frame bar 405 and the right tray frame bar 406 can form the blank parts tray frame 404 for holding the component trays 202. The left tray frame bar 405 and the right tray frame bar 406 are positioned to allow the component trays 202 to pass through the blank parts tray frame 404 in the vertical direction with the component trays 202 in a horizontal orientation.

The tray stacker 402 can include a programmed parts tray frame 412. The programmed parts tray frame 412 is a structure for receiving and holding one of the component trays 202.

The programmed parts tray frame 412 is similar to the blank parts tray frame 404 and includes similar elements with similar names in similar configurations.

The tray stacker 402 can include the unload receptacle 214 for holding the component trays 202. The unload receptacle 214 can include the programmed parts tray frame 412.

The tray stacker 402 can include side covers 414 along the outer sides of the tray stacker 402 and extending from the stacker front end 126 to the stacker back end 128. The side covers 414 are panels that are mounted on the tray stacker 402. The side covers 414 prevent dust and other contamination from entering the tray stacker 402. The side covers 414 can cover airlines and cabling routed underneath the side covers 414. The side covers 414 can extend from the stacker front end 126 to the stacker back end 128.

The tray stacker 402 can include an air manifold housing 416. The air manifold housing 416 is a cover to protect the air distribution manifold 302 of FIG. 3. The air manifold housing 416 is positioned over the air distribution manifold 302 and between the shuttle linear guide 238 and the side of the tray stacker 402.

The tray stacker 402 can include tray positioning arms 418. The tray positioning arms 418 are moveable mechanisms to adjust the position of the component trays 202. The tray positioning arms 418 are positioned within the blank parts tray frame 404 and the programmed parts tray frame 412 for pushing the component trays 202 against the diagonal corner. The tray positioning arms 418 can be partially covered by the air manifold housing 416.

The tray stacker 402 can include the host controller 108 for operating the tray stacker 402. The host controller 108 is located at the stacker back end 128 and below the input stacker 222 and the output stacker 234. The host controller 108 is positioned directly below the input stacker 222 and the output stacker 234. The host controller 108 is directly on the rear panel 244.

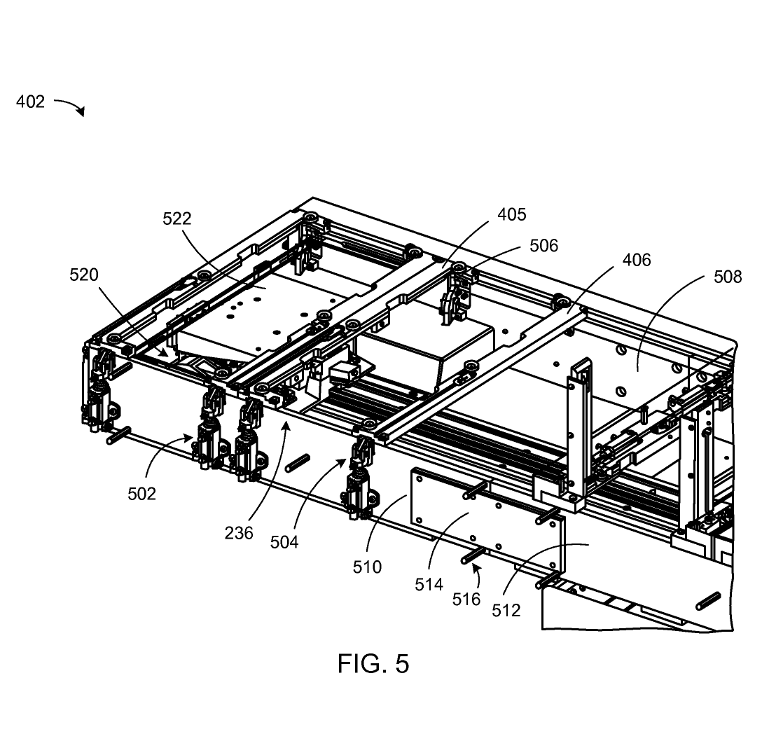

Referring now to FIG. 5, therein is shown an exemplary isometric view of a portion of the tray stacker 402 with clamp cylinders 502. The tray stacker 402 can use the clamp cylinders 502 to push one of the component trays 202 of FIG. 2 against the hard stop bumpers 208 of FIG. 2 to secure the position of the component trays 202.

The tray stacker 402 can include two of the clamp cylinders 502 for each of the left tray frame bar 405 and the right tray frame bar 406. The clamp cylinders 502 are components for lifting the component trays 202 up to be held in place by making contact with the hard stop bumpers 208. The clamp cylinders 502 are mounted on the outside of an inner wall 508 and inside the side covers 414 of FIG. 4. The clamp cylinders 502 are positioned away from the path of the shuttle 236 to allow the shuttle 236 to transport one of the component trays 202.

For example, the clamp cylinders 502 can be double acting pneumatic cylinders with cylinder piston sensors (not shown). The clamp cylinders 502 can keep the component trays 202 in a fixed position against the hard stop bumpers 208.

The tray stacker 402 can include tray lock mechanisms 504 coupled to each of the clamp cylinders 502. The tray lock mechanisms 504 can push one of the component trays 202 against the hard stop bumpers 208 when the clamp cylinders 502 are retracted downward to actuate the tray lock mechanisms 504.

The tray lock mechanisms 504 include lock fingers 506 positioned below the component trays 202. Actuating the tray lock mechanism 504 with the clamp cylinders 502 rotates the tray lock mechanism 504 around a mounting axis and the lock fingers 506 lever upward to move the component trays 202 up against the hard stop bumpers 208.

The tray stacker 402 can include the inner wall 508 having a first inner panel 510, a second inner panel 512, and a joiner panel 514, which can be flat structural elements for enclosing the tray stacker 402. The first inner panel 510 and the second inner panel 512 can be held together by the joiner panel 514. The first inner panel 510 and the second inner panel 512 form a portion of an enclosure for the tray stacker 402. In another example, the inner wall 508 can be a single piece.

The tray stacker 402 can include offset spacers 516 mounted on the inner wall 508. The offset spacers 516 are structural mounting elements for attaching the side covers 414 to the inner wall 508, while providing space to place and operate the clamp cylinders 502 and the tray lock mechanism 504. For example, the offset spacers 516 can be extended segments that are double threaded to mount to the inner wall 508 and the side covers 414.

The tray stacker 402 can include the shuttle 236 coupled to the shuttle linear guide 238 of FIG. 2 for transporting the component trays 202. The shuttle linear guide 238 can have a single or double configuration, such as having two separate instances of the shuttle linear guide 238 used together. The shuttle 236 can position one of the component trays 202 below the blank parts tray frame 404 of FIG. 4, the programmed parts tray frame 412 of FIG. 4, the input stacker 222 of FIG. 2, or the output stacker 234 of FIG. 2.

The shuttle 236 can include a shuttle elevator 520, which is a mechanical structure for raising and lowering the component trays 202. Once the shuttle 236 has positioned one of the component trays 202 in the correct position, the shuttle elevator 520 can raise the component trays 202 to be mounted for use.

The shuttle 236 includes an elevator top plate 522, which is structural element for holding one of the component trays 202. The elevator top plate 522 has a flat upper surface and an angled lower surface. The elevator top plate 522 can be moved vertically as part of the shuttle elevator 520.

It has been discovered that positioning the clamp cylinders 502 on the outside of the inner wall 508 and away from the route of the shuttle 236 along the shuttle linear guide 238 can increase operating speed and increase reliability. Positioning the clamp cylinders 502 away from the shuttle 236 can allow the shuttle 236 to more freely without interfering with the clamp cylinders 502.

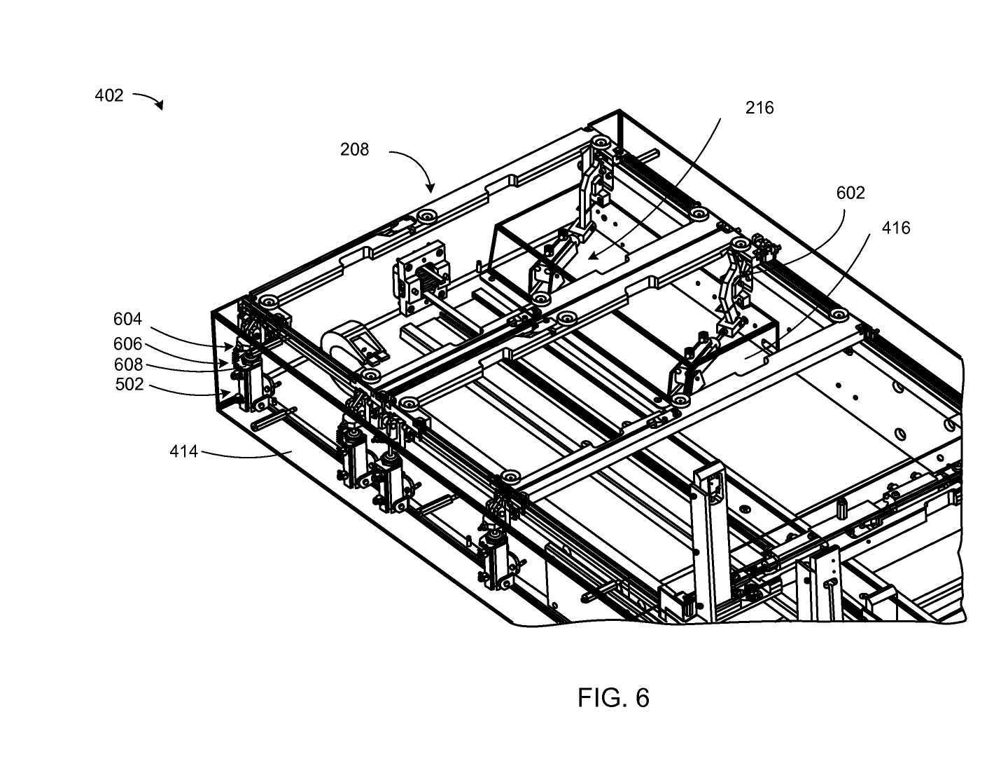

Referring now to FIG. 6, therein is shown an exemplary isometric view of a portion of the tray stacker 402 with the tray positioning cylinders 216 and the tray adjust fingers 602. The tray positioning cylinders 216 can actuate the tray adjust fingers 602 to align the component trays 202 of FIG. 2 against the diagonally opposite corner of blank parts tray frame 404 and the programmed parts tray frame 412.

The tray stacker 402 can include the tray positioning cylinders 216 on the bottom interior of the tray stacker 402 and covered by the air manifold housing 416. The tray positioning cylinders 216 are coupled to the tray adjust fingers 602. When the tray positioning cylinders 216 are actuated and extended, the tray adjust fingers 602 can rotate around the mounting axis and adjust the position of one of the component trays 202 by pushing it against the diagonally opposite corner. For example, the tray positioning cylinders 216 can be extended using pneumatic pressure from the air manifold (not shown).

The tray stacker 402 can include a plurality of the tray positioning cylinders 216 and the tray adjust fingers 602 for the blank parts tray frame 404 of FIG. 4 and the programmed parts tray frame 412 of FIG. 4. The tray adjust fingers 602 can extend through openings in the air manifold housing 416.

The tray stacker 402 can include the side covers 414. The side covers 414 can be mounted on the inner wall 508 of FIG. 5 to protecting the clamp cylinders 502, tray lock mechanisms 504 of FIG. 5, air lines (not shown), and cables (not shown) from dust and other contaminants.

The clamp cylinders 502 can include retract springs 606, which are structural elements for holding retracted the clamp cylinders 502. The tray lock mechanism 504 can include retract spring posts 604, which are structural elements for connecting to the other end of the retract springs 606. The retract springs 606 are connected between the retract spring posts 604 and a retract spring plate 608. The retract spring plate 608 is attached to the base of the clamp cylinders 502 and can be held in place with a nut or other fastener.

The clamp cylinders 502 are for holding one of the component trays 202 up against the hard stop bumpers 208. The retract springs 606 can function to keep the tray lock mechanism 504 actuated in case of loss of air pressure to the clamp cylinders 502.

It has been discovered that the retract springs 606 coupled to the clamp cylinders 502 provides increased reliability by keeping the component trays 202 positioned against the hard stop bumpers 208 during loss of air pressure and preventing the dropping of the component trays 202. The retract springs 606 can keep the tray lock mechanism actuated to prevent the unexpected vertical drop of the component trays 202 and prevent disrupting or misplacing parts on the component trays 202.

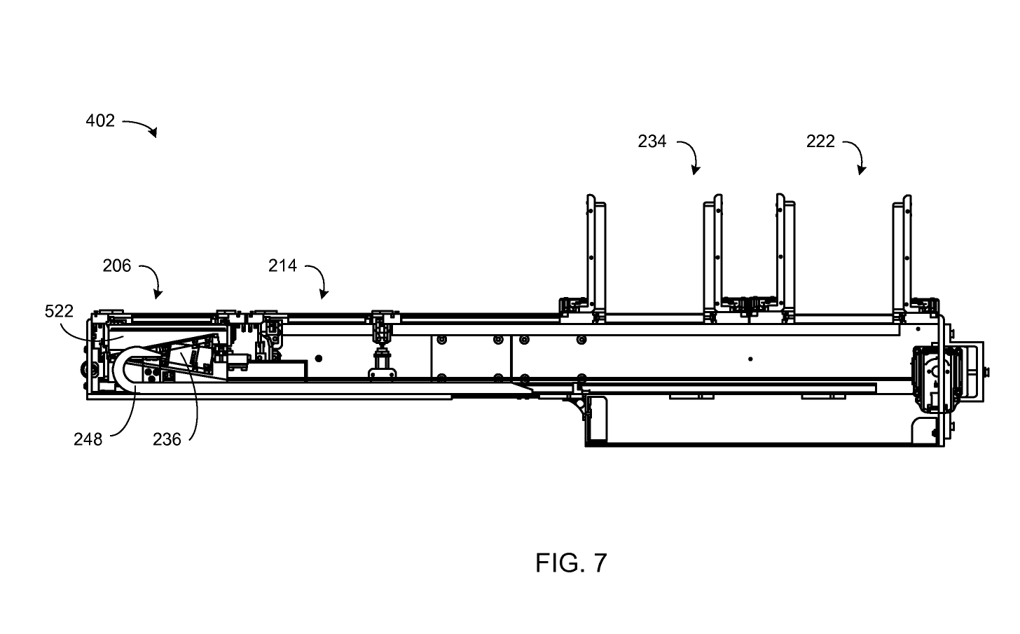

Referring now to FIG. 7, therein is shown an exemplary side view of the tray stacker 402. The tray stacker 402 can transport the component trays 202 of FIG. 2 between the load receptacle 206, the unload receptacle 214, the input stacker 222, and the output stacker 234.

The tray stacker 402 can include the shuttle 236 having the elevator top plate 522 for holding the component trays 202. The shuttle 236 can receive one of the component trays 202 on the elevator top plate 522, lower the elevator top plate 522, move to another location, and raise the elevator top plate 522 holding the component trays 202.

The tray stacker 402 can include the e-chain 248 moving synchronously with the shuttle 236. The e-chain 248 can provide access to the cables to the shuttle 236 while both are in motion.

The tray stacker 402 can include the output stacker 222 located at the stacker back end 128 of FIG. 1. The tray stacker can include the input stacker 234 located between the output stacker 234 and the stacker front end 126 of FIG. 1.

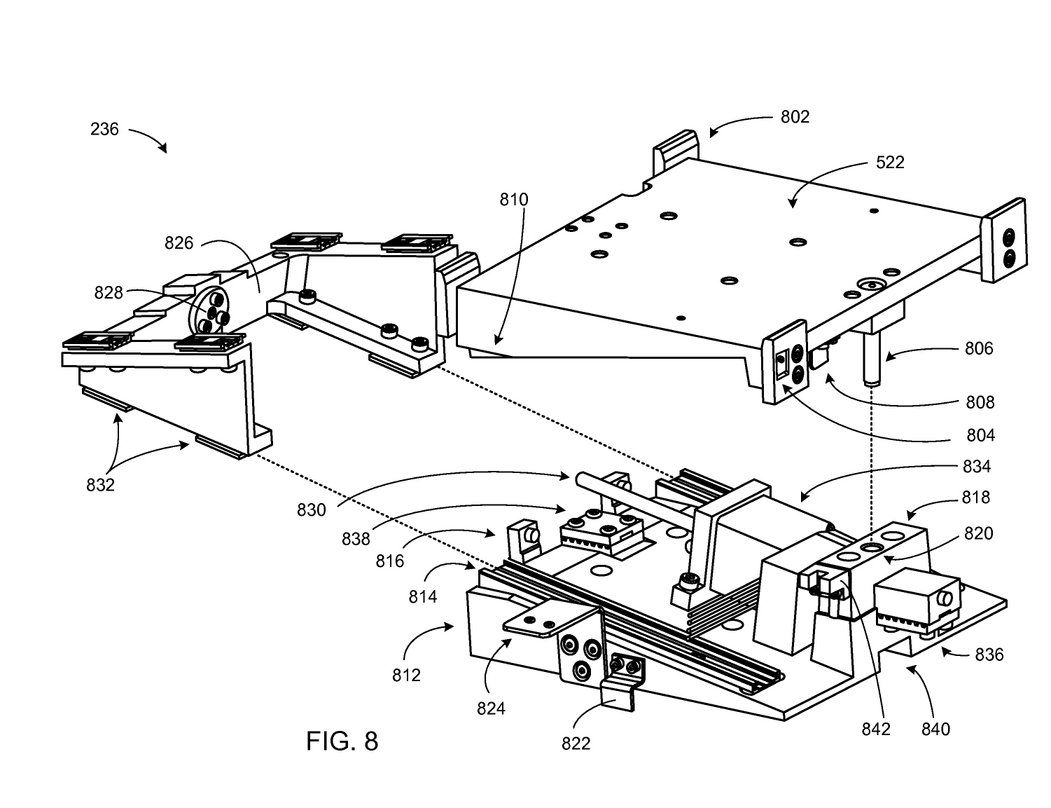

Referring now to FIG. 8, therein is shown an exploded view of the shuttle 236. The shuttle 236 is a mechanism for transporting the component trays 202 of FIG. 2 within the tray stacker 402 of FIG. 4.

The shuttle 236 can move the component trays 202 horizontally and includes the shuttle elevator 520 of FIG. 5 for moving the component trays 202 vertically. The shuttle elevator 520 is a mechanical structure for moving the component trays 202 vertically on the shuttle 236. The shuttle 236 can include a shuttle base 812, a wedge block 826, and the elevator top plate 522, which are described below in detail.

The shuttle 236 includes the elevator top plate 522 for holding one of the component trays 202. The elevator top plate 522 has a flat upper surface and an angled lower surface.

The elevator top plate 522 can include tray guides 802 mounted on the front and back sides of the elevator top plate 522. The tray guides 802 are rectangular structures for holding one of the component trays 202.

The tray guides 802 are shaped to provide a beveled surface on the top side for guiding one of the component trays 202 onto the elevator top plate 522. The elevator top plate 522 can have four of the tray guides 802 with two of the tray guides 802 mounted on the back side of the elevator top plate 522 and two of the tray guides 802 mounted on the front side of the elevator top plate 522.

The elevator top plate 522 can include a reflective tray sensor 804, which is a component for detecting the presence of the component trays 202 on the elevator top plate 522. For example, the reflective tray sensor 804 can receive an optical signal that can be blocked by the presence of the component trays 202.

The elevator top plate 522 can include a top plate vertical guide 806, which is a linear structure for guiding the elevator top plate 522 in the vertical direction. The top plate vertical guide 806, such as rod or cylindrical element, can constrain the horizontal motion of the elevator top plate 522 to provide vertical motion without a horizontal offset when the shuttle elevator 520 is actuated.

The elevator top plate 522 can include a home vertical tag 808, which is a flat structural element. The home vertical tag 808 can be used to detect the vertical home position of the elevator top plate 522.

The elevator top plate 522 can include top linear guides 810, which are sliding track elements. The top linear guides 810 can be mounted on the bottom side of the elevator top plate 522.

The shuttle 236 can include the shuttle base 812, which is a structural element for moving the shuttle 236 and the shuttle elevator 520. The shuttle base 812 can have a flat bottom side and an angled top surface higher at the front side than at the rear side of the shuttle base. The angled top surface and the bottom side of the shuttle base 812 can form a base angle.

The shuttle base 812 can include wedge linear guides 814, which are track structures for movably coupling other shuttle components. The shuttle base 812 can include two wedge linear guides 814 attached to the angled top surface of the shuttle base 812. The wedge linear guides 814 are positioned on either side of the angled top surface of the shuttle base 812.

The shuttle base 812 can include a shuttle encoding motor 834 having a leadscrew 830. The shuttle encoding motor 834 can rotate the leadscrew 830 to drive other shuttle components.

The shuttle base 812 can attach to the shuttle drive belt 240 of FIG. 2. The shuttle drive belt 240 can move the shuttle 236 in the horizontal direction along the shuttle linear guide 238 of FIG. 2.

The shuttle base 812 can include a shuttle rear connector 836 at the back end of the shuttle base 812. The shuttle rear connector 836 is a mechanical structure for attaching to the end of the shuttle drive belt 240.

The shuttle base 812 can include a front belt clamp 838 at the front end of the shuttle base 812. The front belt clamp 838 is a mechanical structure for attaching to another end of the shuttle drive belt 240.

The shuttle base 812 can include a bottom belt clearance channel 840, which is a structural feature of the shuttle base 812 for routing the shuttle drive belt 240 through the shuttle base 812. For example, the bottom belt clearance channel 840 can be an opening sized to couple with the shuttle linear guide 238.

The shuttle base 812 can include shuttle base bumpers 816, which are protective elements for limiting the motion of the wedge block 826 in the horizontal direction. The shuttle base bumpers 816 are attached to the front end of the shuttle base 812. The shuttle base bumpers 816 can prevent the wedge base 826 from over-travelling in the forward direction. The shuttle base 812 can include a base mount 818, which is a structural element for coupling to the elevator top plate 522. The base mount 818 is located at the back end of the shuttle base 812.

The base mount 818 includes a top guide receiver 820, which is an opening in the base mount 818. The base mount 818 couples to the top plate vertical guide 806 to constrain the elevator top plate 522 to allow only vertical motion.

The base mount 818 includes a vertical home sensor 842, which is an element for detecting the location of the elevator top plate 522. The vertical home sensor 842 can detect the presence of the home vertical tag 808 on the elevator top plate 522 to determine the vertical home position of the elevator top plate 522.

The shuttle base 812 can include a shuttle home sensor flag 822, which is a flat structural element. The shuttle home sensor flag 822 can be used to detect the horizontal position of the shuttle 236 along the shuttle linear guide 238.

The shuttle base 812 can include an e-chain mounting bracket 824. The e-chain mounting bracket 824 is a structural element for coupling to the e-chain 248 of FIG. 2. The e-chain 248 can be attached to the e-chain mounting bracket 824 to move the e-chain synchronously with the shuttle 236.

The shuttle 236 can include the wedge block 826, which is an angled structure driven by the leadscrew 830 for moving the elevator top plate 522 in the vertical direction. The wedge block 826 can form a U-shaped wedge having a wedge angle. The wedge angle is twice the angle of the shuttle base angle.

The wedge block 826 can include a leadscrew receiver nut 828, which is a mechanical coupling to the leadscrew 830. The leadscrew receiver nut 828 is fixed to the front side of the wedge block 826.

The leadscrew 830 includes a central opening having threads matching the leadscrew 830. The leadscrew receiver nut 828 can be screwed into the leadscrew 830 to drive the leadscrew receiver nut 828 along the leadscrew 830 as the leadscrew 830 rotates. As the leadscrew 830 rotates and drives the leadscrew receiver nut 828 along the leadscrew 830, the leadscrew receiver nut 828 moves the wedge block 826 along the leadscrew 830 and along the wedge linear guides 814.

The motion of the wedge block 826 along the leadscrew 830 causes the wedge block 826 to move away and upward from the shuttle encoding motor 834 on the shuttle base 812. The motion of the wedge block 826 can cause the elevator top plate 522 to move in the vertical direction. The motion of the elevator top plate 522 is constrained in the horizontal direction by the top plate vertical guide 806.

The wedge block 826 can include linear guide blocks 832, which are sliding elements that couple with the wedge linear guides 814 and the top linear guides 810. The linear guide blocks 832 can be inserted into the wedge linear guides 814 and allow the wedge block 826 to move freely along the path of the wedge linear guides 814. The linear guide blocks 832 can form a tongue-in-groove interface with the wedge linear guides 814 and the top linear guides 810.

The wedge block 826 can include two of the linear guide blocks 832 on each side of the bottom side of the wedge block 826 to couple with the wedge linear guides 814 on the shuttle base 812. The wedge block 826 can include two of the linear guide blocks 832 mounted on the top of the wedge block 826 for coupling with each of the top wedge guides of the elevator top plate 522.

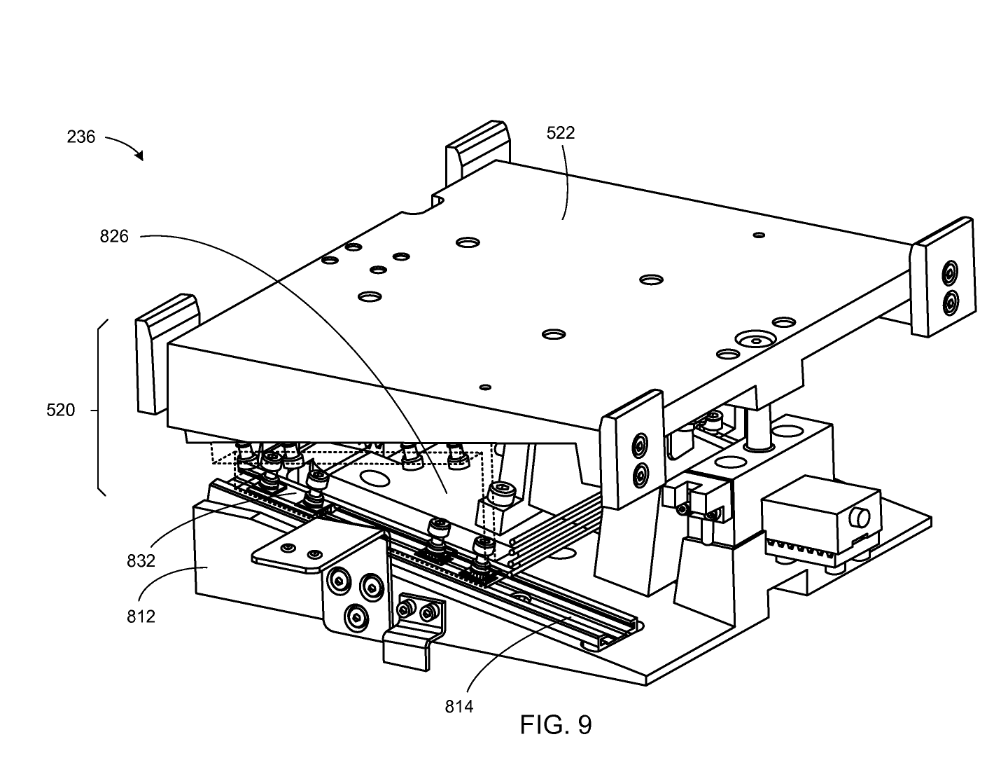

Referring now to FIG. 9, therein is shown a first exemplary isometric view of the shuttle 236. The shuttle 236 is shown with the wedge block 826 transparent to expose the inner portions of the wedge block 826.

The shuttle 236 can include the shuttle base 812 and the shuttle elevator 520. The shuttle elevator 520 includes the wedge block 826 and the elevator top plate 522. The shuttle elevator 520 can be in a lowered position with the elevator top plate 522 and the wedge block 826 both directly over the shuttle base 812.

The wedge block 826 can include the linear guide blocks 832 inserted within the wedge linear guides 814 attached to the shuttle base 812. The linear guide blocks 832 can be attached to the wedge block 826 with fasteners, such as a screw, bolt, adhesive, or a combination thereof.

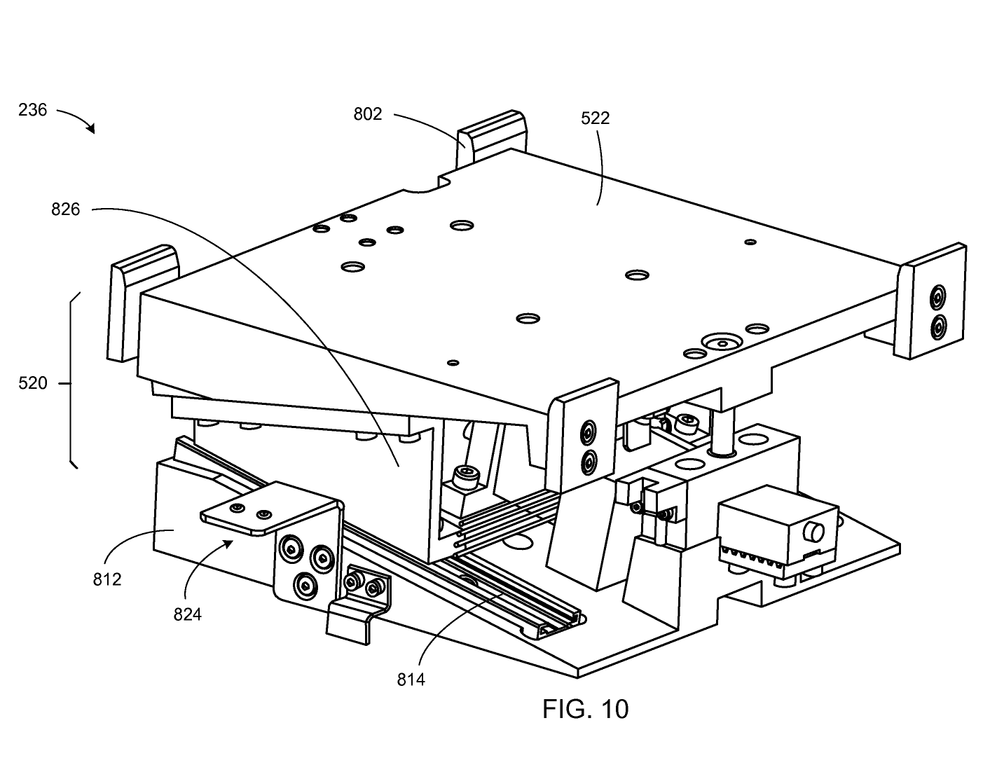

Referring now to FIG. 10, therein is shown a second exemplary isometric view of the shuttle 236. The shuttle elevator 520 is shown with the wedge block 826 opaque.

The shuttle elevator 520 can include the elevator top plate 522. The component trays 202 of FIG. 2 can be positioned on the top surface of the elevator top plate 522 and held in place in the forward and backward directions by four of the tray guides 802. The tray guides 802 can include a beveled inner upper surface for facilitating receiving the component trays 202. The component trays 202 fit loosely between the tray guides 802. The side-to-side movement of the component trays 202 can be constrained by the inner wall 508 of FIG. 5 and the component trays 202 are guided by the guide tape 220 of FIG. 2.

The shuttle 236 can include the shuttle base 812. The shuttle base 812 can include the e-chain mounting bracket 824 attached to the side of the shuttle base 812 by fasteners, such as screws. The e-chain mounting bracket 824 is for coupling the e-chain 248 of FIG. 2 to the shuttle 236 to allow the cable and tubes (not shown) in the e-chain 248 to follow the motion of the shuttle 236.

The shuttle base 812 can include two wedge linear guides 814 attached to the angled top surface of the shuttle base 812. The wedge linear guides 814 are positioned on either side of the angled top surface of the shuttle base 812.

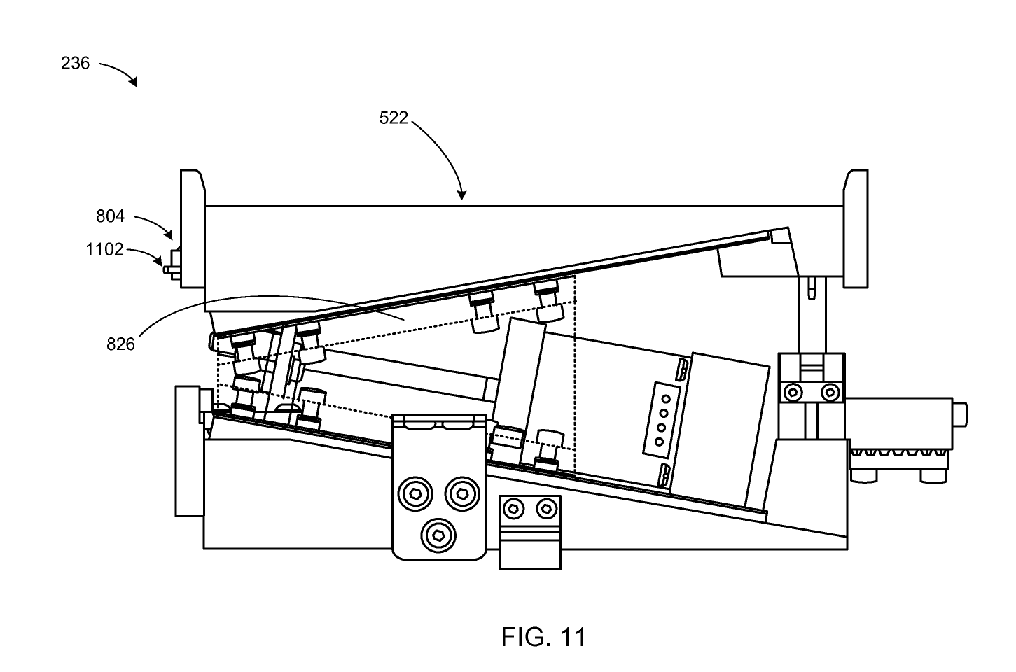

Referring now to FIG. 11, therein is shown an exemplary side view of the shuttle 236. The shuttle 236 is shown with the wedge block 826 transparent to show in the interior of the shuttle 236.

The shuttle 236 can include the reflective tray sensor 804 attached to the elevator top plate 522 for detecting the presence of one of the component trays 202 of FIG. 2 on the elevator top plate 522. The reflective tray sensor 804 can detect when the component trays 202 interrupts a beam of light indicating that one of the component trays 202 is on the elevator top plate 522.

The reflective tray sensor 804 can be attached to a sensor mount 1102 with a fastener, such as a screw. The sensor mount 1102 is a structural element on the elevator top plate 522 for attaching the reflective tray sensor 804.

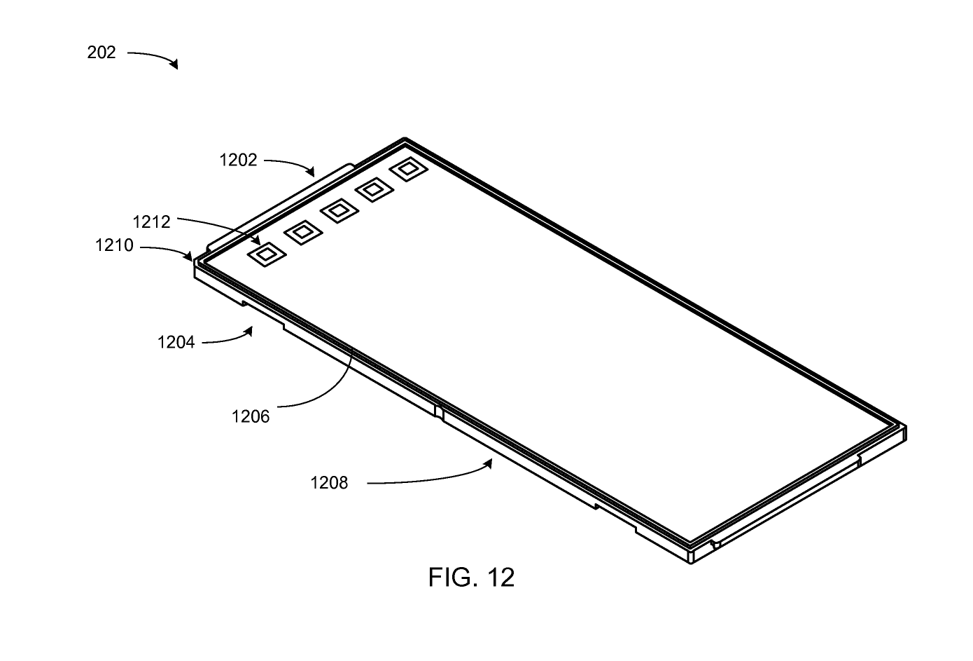

Referring now to FIG. 12 therein is shown an isometric view of the component tray 202. The component trays 202 can be attached to the elevator top plate 522 of FIG. 5 of the shuttle 236 of FIG. 2.

The component trays 202 are a rectangular flat structure for holding electrical components 1212. The component tray 202 can also have device pockets (not shown) for holding electrical components 1212. The component trays 202 can have two short edges and two longer edges.

The component trays 202 can include restraining flanges 1202 along the shorter edges of the component trays 202. The restraining flanges 1202 are for supporting the component trays 202. For example, the restraining flanges 1202 can be in contact with the guide tape 220 of FIG. 2.

The component trays 202 can include tray lock recesses 1204 along the longer edges of the component trays 202. The tray lock recesses 1204 are for engaging with the lock arm 230 of FIG. 2 to support the component trays 202. The component trays 202 can include two of the tray lock recesses 1204 on each of the longer edges of the component trays 202 for a total of four of the tray lock recesses 1204. The tray lock recesses 1204 are used to separate and hold the component trays 202.

The component trays 202 can include a tray perimeter ledge 1206 along the outer perimeter of the top surface of the component trays 202 and offset from the outer edge of the component trays 202. The tray perimeter ledge 1206 is a structure extending from the component trays 202 for retaining components on the component trays 202. For example, the tray perimeter ledge 1206 can extend 2 millimeters (mm) from the surface of the component trays 202. The electrical components 1212 in the device pockets do not extend above the tray perimeter ledge 1206.

The component trays 202 can include a tray bottom skirt 1208 along the outer perimeter of the bottom of the component trays 202. The tray bottom skirt 1208 can engage with the tray perimeter ledge 1206 to form stacks of the component trays 202. The electrical components 1212 in the device pockets do not extend above the height of the tray perimeter ledge 1206. The electrical components 1212 can be enclosed by the one of the component trays 202 mounted over another of the component trays 202.

The component trays 202 can include a tray chamfer 1210, which is an angled edge at the corner of the component trays 202 representing the pin 1 orientation for the electrical components 1212. For example, the tray chamfer 1210 can be formed an angle of 45 degrees on the corner of the component trays 202.

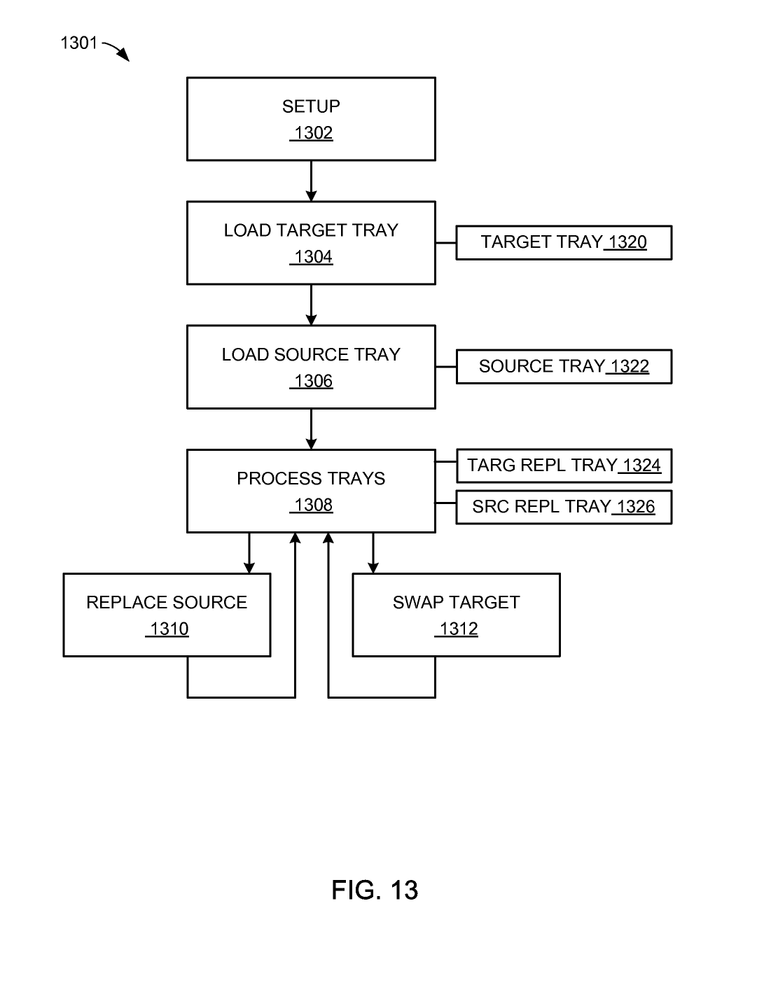

Referring now to FIG. 13, therein is shown a control flow 1301 of the tray stacker system 100 of FIG. 1. Operation of the tray stacker system 100 includes a setup step 1302, a load target tray step 1304, a load source tray step 1306, a process trays step 1308, a replace source tray step 1310, and a swap target tray step 1312.

In the setup step 1302, the input stacker 222 of FIG. 2 can receive a stack of the component trays 202 of FIG. 2 having the electrical components 1212 of FIG. 12 that are unprocessed. Unprocessed can indicate blank, unprogrammed, untested, or a combination thereof. For example, an operator can load up to 25 of the component trays 202 full of the electrical components 1212 that are unprogrammed.

The output stacker 234 of FIG. 2 can receive one of the component trays 202 that is empty and does not have any electrical components 1212. For example, the operator can load one of the component trays 202 empty of the electrical components 1212 into the output stacker 234.

In the load target tray step 1304, the tray stacker 402 of FIG. 4 can load a target tray 1320 from the output stacker 234 into the load receptacle 206 of FIG. 2. The target tray 1320 is one of the component trays 202 that is empty. The target tray 1320 does not have the electrical components 1212 on the component trays 202. The tray stacker 402 can remove the target tray 1320 from the output stacker 234, move the target tray 1320 to the load receptacle 206, and secure the target tray 1320 in the load receptacle 206. The load receptacle 206 can receive the target tray 1320 from the output stacker 234.

The tray stacker 402 can remove the target tray 1320 from the output stacker 234 by positioning the shuttle 236 of FIG. 2 below the output stacker 234 and raising the shuttle elevator 520 of FIG. 5 until it contacts the target tray 1320. The tray stacker 402 can then disengage the stacker lock cylinders 232 of FIG. 2 of the output stacker 234 and lower the shuttle elevator 520 by the height of one of the component trays 202. If there are more than one of the component trays 202 in the output stacker 234, then the stacker lock cylinders 232 of the output stacker 234 can be reengaged to secure the component trays 202 remaining in the output stacker 234.

The tray stacker 402 can move the target tray 1320 to the load receptacle 206. The shuttle elevator 520 can lower the target tray 1320 until the elevator motor encoder (not shown) determines the elevator top plate 522 of FIG. 5 is lowered to an appropriate position. Once the shuttle elevator 520 is in the lowered position, the shuttle 236 can move along the shuttle linear guide 238 of FIG. 2 until it is positioned below the load receptacle 206. The shuttle elevator 520 can raise the target tray 1320 until the elevator motor encoder determines the target tray 1320 is in position.

The tray stacker 402 can secure the target tray 1320 in the load receptacle 206. The tray stacker 402 can attach the target tray 1320 to the load receptacle 206 using the tray lock mechanism 504 of FIG. 5. Once the target tray 1320 is positioned by the elevator motor encoder, the tray positioning cylinders 216 of FIG. 2 can actuate the tray adjust fingers 602 of FIG. 6 to push the target tray 1320 diagonally against the opposite interior sides of the load receptacle 206 to insure the proper positioning of the target tray 1320.

The clamp cylinders 502 of FIG. 5 can actuate the lock fingers 506 of FIG. 5 of the tray lock mechanisms 504 to push the target tray 1320 up against the hard stop bumpers 208 of FIG. 2 of the load receptacle 206. The clamp cylinders 502 and the retract springs 606 of FIG. 6 can hold the component trays 202 against the hard stop bumpers 208.

In the load source tray step 1306, the tray stacker 402 can load a source tray 1322 from the input stacker 222 into the unload receptacle 214 of FIG. 2. The source tray 1322 is one of the component trays 202 having the electrical components 1212 for programming. The tray stacker 402 can remove the source tray 1322 from the input stacker 222, move the source tray 1322 to the unload receptacle 214, and secure the source tray 1322 to the unload receptacle 214. The unload receptacle 214 can receive the source tray 1322 from the input stacker 222.

The tray stacker 402 can remove the source tray 1322 from the input stacker 222 by positioning the shuttle 236 below the input stacker 222 and raising the shuttle elevator 520 until it contacts the source tray 1322. The tray stacker 402 can then disengage the stacker lock cylinders 232 of the input stacker 222 and lower the shuttle elevator 520 by the height of one of the component trays 202. If there are more than one of the component trays 202 in the input stacker 222, then the stacker lock cylinders 232 of the input stacker 222 can be reengaged to secure the component trays 202 remaining in the input stacker 222.

The tray stacker 402 can move the source tray 1322 to the unload receptacle 214. The shuttle elevator 520 can lower the source tray 1322 until the elevator top plate 522 is lowered to the position measured by the elevator motor encoder. Once the shuttle elevator 520 is in the lowered position, the shuttle 236 can move along the shuttle linear guide 238 until it is positioned below the unload receptacle 214. The shuttle elevator 520 can raise the source tray 1322 until the elevator motor encoder detects the source tray 1322 is in position.

The tray stacker 402 can secure the source tray 1322 in the unload receptacle 214. The tray stacker 402 can attach the target tray 1320 to the unload receptacle 214 using the tray lock mechanism 504. The tray positioning cylinders 216 can actuate the tray adjust fingers 602 to push the source tray 1322 diagonally against the opposite interior sides of the unload receptacle 214 to insure the proper positioning of the source tray 1322.

The clamp cylinders 502 can actuate the lock fingers 506 of the tray lock mechanisms 504 to push the source tray 1322 up against the hard stop bumpers 208 of the unload receptacle 214. The clamp cylinders 502 and the retract springs 606 can hold the source tray 1322 against the hard stop bumpers 208.

In the process trays step 1308, the tray stacker 402 can process the electrical components 1212 on the source tray 1322 and transfer the electrical components 1212 from the source tray 1322 onto the target tray 1320 via the programming station 106 of FIG. 1. The tray stacker 402 can process the electrical components 1212 until the target tray 1320 is full or until the source tray 1322 is empty.

The electrical components 1212 can be processed in a variety of way. For example, the electrical components 1212 can be removed from the source tray 1322 and loaded into the programming station 106 to be programmed. After programming, the electrical components 1212 can be moved from the programming station to the target tray 1320. Processing can include programming, testing, configuring, or a combination thereof.

The programming station 106 can be an EEPROM programmer, a FPGA programmer, a flash memory programmer, an integrated circuit configuration device, or a combination thereof. The electrical components 1212 can be transferred from the source tray 1322 to the programming station 106 using a pick-and-place system. For example, the pick-and-place system can be the host machine robot 114 of FIG. 1 having the horizontal rails 112 of FIG. 1 and the horizontal arm 116 of FIG. 1 for moving and positioning the electrical components 1212.

If any of the electrical components 1212 are determined to be defective during programming, then the defective components can be transferred to a reject station (not shown) and the electrical components 1212 that are good can be transferred to the target tray 1320. Because of the likelihood that some of the electrical components 1212 can be defective, the source tray 1322 can run out of the electrical components 1212 to process before the target tray 1320 is completely full.

While processing the electrical components 1212, the tray stacker 402 can detect when the source tray 1322 is empty and replace the source tray 1322 with a source replacement tray 1326. The source replacement tray 1326 is one of the component trays 202 that is full of the electrical components 1212.

The tray stacker 402 can detect when the source tray 1322 is empty in a variety of ways. For example, the tray stacker 402 can maintain a count of the number of the electrical components 1212 that have been removed from the source tray 1322 and determine the source tray 1322 is empty when the count indicates that there are no more of the electrical components 1212 on the source tray 1322. The information for the count of the electrical components 1212 can be collected via communication with the external controller (not shown).

In another example, the external controller can detect that the source tray 1322 is empty using an optical sensor (not shown) to detect the presence of the electrical components 1212 on the source tray 1322. In yet another example, the external controller can detect that the source tray 1322 is empty by failing to pick up one of the electrical components 1212 by the host machine robot 114 of FIG. 1.

While processing the electrical components 1212, the tray stacker 402 can detect when the target tray 1320 is full and replace the target tray 1320 with a target replacement tray 1324. The target replacement tray 1324 is one of the component trays 202 empty of the electrical components 1212.

The tray stacker 402 can detect when the target tray 1320 is full in a variety of ways. For example, the tray stacker 402 can maintain a count of the number of the electrical components 1212 that have been programmed and placed on the target tray 1320. The information for the count of the electrical components 1212 can be collected via communication with the external controller.

In another example, the external controller can detect that the target tray 1320 is full using an optical sensor (not shown) to detect the presence of the electrical components 1212 on the target tray 1320. In yet another example, the external controller can detect that the source tray 1322 is full by failing to place one of the electrical components 1212 on the target tray 1320 by the host machine robot 114.

If the source tray 1322 is empty before the target tray 1320 is full, then the control flow 1301 can pass to the replace source tray step 1310. If the target tray 1320 is full before the source tray 1322 is empty, then the control flow 1301 can pass to the swap target tray step 1312.

The component picker (not shown) can transfer the electrical components 1212 in a variety of ways. For example, the component picker can transfer the by picking up the electrical components 1212 from the source tray 1322 in the unload receptacle 214, processing the electrical components 1212, and placing the electrical components 1212 on the target tray 1320 in the load receptacle 206.

In the replace source tray step 1310, the tray stacker 402 can detect that the source tray 1322 is empty and replace the source tray 1322 with the source replacement tray 1326. The source replacement tray 1326 can be retrieved from the input stacker 222. The source tray 1322 that is empty can be moved to the output stacker 234 for reuse as the target replacement tray 1324.

When the source tray 1322 is empty and has no more of the electrical components 1212, the tray stacker 402 can transfer the source tray 1322 that is empty to the bottommost position in the output stacker 234. The source tray 1322 that is empty can be reused as the target replacement tray 1324 in a later operation.

The tray stacker 402 can position the shuttle 236 below the load receptacle 206 and raise the shuttle elevator 520 to contact the source tray 1322. The load receptacle 206 can unlock the tray lock mechanism 504 to release the source tray 1322.

The shuttle elevator 520 can raise the elevator top plate 522 using the shuttle encoding motor 834 of FIG. 8 to rotate the leadscrew 830 of FIG. 8 and move the wedge block 826 of FIG. 8 back and forth as the leadscrew receiver nut 828 of FIG. 8 drives against the wedge block 826. The linear guide blocks 832 of FIG. 8 of the wedge block 826 can slide within the wedge linear guides 814 of FIG. 8 of the shuttle base 812 and the top linear guides 810 of FIG. 8 of the elevator top plate 522 to move the elevator top plate 522 vertically. The elevator top plate 522 is held in place horizontally by the top plate vertical guide 806 of FIG. 8, which moves vertically within the top guide receiver 820 of FIG. 8 mounted on the shuttle base 812.

Once the elevator top plate 522 of the shuttle elevator 520 is in contact with the source tray 1322 that is empty, the tray stacker 402 can then disengage the clamp cylinders 502 and de-actuate the lock fingers 506 of the tray lock mechanism 504 to release the source tray 1322. The source tray 1322 can rest on the elevator top plate 522 by the tray guides 802 of FIG. 8.

The shuttle elevator 520 can lower the source tray 1322 on the elevator top plate 522 based on the motor encoder. Once the shuttle elevator 520 is in the lowered position, the shuttle 236 can move along the shuttle linear guide 238 until it is positioned below the output stacker 234.

The shuttle elevator 520 can raise the source tray 1322 that is empty and insert the source tray 1322 into the output stacker 234. The shuttle elevator 520 can raise the source tray 1322 until the motor encoder indicates the source tray 1322 is in position. The home switches are used upon powering up the system to calibrate the motor encoder. Thereafter all motion is based on the motor encoder.

If the output stacker 234 has one or more of the component trays 202 in the output stacker 234, then the tray perimeter ledge 1206 of FIG. 12 of the source tray 1322 will engage with the tray bottom skirt 1208 of FIG. 12 of the bottommost of the component trays 202 already in the output stacker 234. The shuttle elevator 520 will push up the entire stack of the component trays 202 in the output stacker 234 with each of the component trays 202 supported by the component trays 202 directly below.

The tray stacker 402 can attach the source tray 1322 to the output stacker 234 with the stacker tray lock 228 of FIG. 2 having the lock arm 230 of FIG. 2 and the stacker lock cylinder 232. The stacker lock cylinder 232 will actuate the lock arm 230 to engage with the source tray 1322 to attach the source tray 1322 in place at the bottom of the output stacker 234. The source tray 1322 that is empty and loaded in the bottommost position of the output stacker 234 will become the target replacement tray 1324. Because the target replacement tray 1324 is empty, it can serve the same function as the target tray 1320 and be used to receive the electrical components 1212 in later operations.

Once the source tray 1322 that is empty has been stacked in the output stacker 234, the tray stacker 402 then can retrieve the source replacement tray 1326 and move the source replacement tray 1326 to the unload receptacle 214. The control flow 1301 can then pass to the process trays step 1308. The source replacement tray 1326 can serve the same function as the source tray 1322 and be used to provide the electrical components 1212 in later operations.

The shuttle elevator 520 can be lowered to the travel position and the shuttle 236 can be moved to a position below the input stacker 222. The shuttle elevator 520 can be raised to make contact with the source replacement tray 1326.

The tray stacker 402 can release the stacker tray lock 228 to free the source replacement tray 1326. The shuttle elevator 520 can lower the stack of the component trays 202 in the input stacker 222 by the height of one of the component trays 202. The stacker tray lock 228 can then engage the component tray 202 above the source replacement tray 1326 to secure the stack of the component trays 202 in the input stacker 222.

The tray stacker 402 can lower the shuttle elevator 520 to the travel position. The shuttle 236 can move to a position below the unload receptacle 214. The shuttle elevator 520 can raise the source replacement tray 1326 until the motor encoder indicates the source replacement tray 1326 is in position.

The tray stacker 402 can secure the source replacement tray 1326 to the unload receptacle 214 with the tray lock mechanism 504. After the source replacement tray 1326 has been detected in the unload receptacle 214, the tray stacker 402 can then adjust the position of the source replacement tray 1326 with the tray positioning arms 418 of FIG. 4 of the unload receptacle 214. The tray stacker 402 can then engage the clamp cylinders 502 of FIG. 5 to actuate the lock fingers 506 of the tray lock mechanism 504 to secure the source replacement tray 1326 against the hard stop bumpers 208 of the unload receptacle 214.

Once the source replacement tray 1326 has been secured in the unload receptacle 214, the source replacement tray 1326 can serve the same function as the source tray 1322 and be used to provide the electrical components 1212 in later operations. The control flow can then pass back to the process trays step 1308. The control flow continues until there are no more of the source tray 1322 in the input stacker 222.

The replace source tray step 1310 describes moving the source tray 1322 to the output stacker 234 and then moving the source replacement tray 1326 to the unload receptacle 214. However, it is understood that swapping the component trays 202 can be performed in alternate orderings.

In the swap target tray step 1312, the tray stacker 402 can detect that the target tray 1320 is full and replace the target tray 1320 with the target replacement tray 1324 that is empty. The target tray 1320 in the load receptacle 206 can be swapped with the target replacement tray 1324 in the bottom most position in the output stacker 234.

The tray stacker 402 can move the target tray 1320 that is full to the bottommost position of the output stacker 234 and load the target replacement tray 1324 that is empty that was previously in the bottommost position of the output stacker 234. The target tray 1320 and the target replacement tray 1324 can swap positions. Swapping is defined as exchanging the location of two of the component trays 202. The term shuffling can also be described as swapping.

For example, the target tray 1320 is moved to the location of the target replacement tray 1324 and the target replacement tray 1324 is moved to the location of the target tray 1320. Swapping the component trays 202 can include placing the component trays 202 in temporary holding locations, such as the input stacker 222, the output stacker 234, the load receptacle 206, the unload receptacle 214, or a combination thereof.

The tray stacker 402 can swap the target tray 1320 with the target replacement tray 1324 by first moving the target replacement tray 1324 from the bottommost position of the output stacker 234 to the temporary holding location at the bottommost position of the input stacker 222. The target tray 1320 that is full of the electrical components 1212 can then be moved from the load receptacle 206 to the bottommost position of the output stacker 234. The target replacement tray 1324 can then be moved from the temporary holding location at the bottommost position of the input stacker 222 to the load receptacle 206.

The tray stacker 402 can move the target replacement tray 1324 from the output stacker 234 to the input stacker 222. The target replacement tray 1324 can be one of the component trays 202 that is empty of the electrical components 1212. For example, the source tray 1322 that has been emptied of the electrical components 1212 can be positioned in the bottommost position of the output stacker 234 as shown in the replace source tray step 1310.

The tray stacker 402 can position the shuttle 236 below the output stacker 234 and raise the shuttle elevator 520 to contact the target replacement tray 1324. Once the elevator top plate 522 is in contact with the target replacement tray 1324, the output stacker 234 can release the target replacement tray 1324 by retracting the stacker lock cylinders 232 of the stacker locks 228 of the output stacker 234. The shuttle elevator 520 can then lower the stack of the component trays 202 in the output stacker 234 by the height of one of the component trays 202 and secure the component tray 202 above the target replacement tray 1324.

The shuttle elevator 520 can lower the target replacement tray 1324 to the travel position and the shuttle 236 can move to a position below the input stacker 222. The shuttle elevator 520 can raise the target replacement tray 1324 until the motor encoder determines the target replacement tray 1324 is in position. The input stacker 222 can be used as a buffer location while shuffling the target tray 1320 and the target replacement tray 1324 that is empty.

If the input stacker 222 has one or more of the component trays 202 in the input stacker 222, then the tray perimeter ledge 1206 of the target tray 1320 will engage with the tray bottom skirt 1208 of the bottommost of the component trays 202 already in the input stacker 222. The shuttle elevator 520 will push up the entire stack of the component trays 202 in the input stacker 222 with each of the component trays 202 supported by the component trays 202 directly below. The stacker locks 228 will actuate the lock arm 230 to secure the target replacement tray 1324 to hold the target replacement tray 1324 in place at the bottom of the input stacker 222.

Once the target replacement tray 1324 has been inserted in the input stacker 222, the shuttle elevator 520 can be lowered to the travel position. The shuttle 236 can be moved along the shuttle linear guide 238 until positioned below the load receptacle 206 and raise the shuttle elevator 520 to contact the target tray 1320 that is full.

Once the elevator top plate 522 of the shuttle elevator 520 is in contact with the target tray 1320 that is full, the tray stacker 402 can then disengage the clamp cylinders 502 and de-actuate the lock fingers 506 of the tray lock mechanism 504 to release the target tray 1320. The target tray 1320 can be held in contact with the elevator top plate 522 by the tray guides 802.

The shuttle elevator 520 can lower the target tray 1320 on the elevator top plate 522 until the motor encoder indicates the target tray 1320 is in position. Once the shuttle elevator 520 is in the travel position, the shuttle 236 can move along the shuttle linear guide 238 until the shuttle 236 is positioned below the output stacker 234.

The tray stacker 402 can insert the target tray 1320 into the bottommost position of the output stacker 234 using the shuttle elevator 520. The shuttle elevator 520 can raise the elevator top plate 522 using the shuttle encoding motor 834 to rotate the leadscrew 830 and move the wedge block 826 forward as the leadscrew receiver nut 828 drives against the wedge block 826. The linear guide blocks 832 of the wedge block 826 can slide within the wedge linear guides 814 of the shuttle base 812 and the top linear guides 810 of the elevator top plate 522 to move the elevator top plate 522 vertically. The elevator top plate 522 is held in place horizontally by the top plate vertical guide 806, which moves vertically within the top guide receiver 820 mounted on the shuttle base 812.

If the output stacker 234 has one or more of the component trays 202 in the output stacker 234, then the tray perimeter ledge 1206 of the target tray 1320 will engage with the tray bottom skirt 1208 of the bottommost of the component trays 202 already in the output stacker 234. The shuttle elevator 520 will push up the entire stack of the component trays 202 in the output stacker 234 with each of the component trays 202 supported by the component trays 202 directly below. The stacker tray locks 228 can actuate the lock arm 230 to secure the target tray 1320 in place at the bottom of the output stacker 234.

The tray stacker 402 can lower the shuttle elevator 520 to the travel position and move the shuttle 236 along the shuttle linear guide 238 to a position below the input stacker 222. The tray stacker 402 can raise the shuttle elevator 520 to contact the target replacement tray 1324. Once the elevator top plate 522 is in contact with the target replacement tray 1324, the input stacker 222 can release the target replacement tray 1324 by retracting the stacker lock cylinders 232 of the stacker tray locks 228 of the input stacker 222. The shuttle elevator 520 can then lower the stack of the component trays 202 in the input stacker 222 by the height of one of the component trays 202 and secure the component tray 202 above the target replacement tray 1324 with the stacker tray locks 228.

The shuttle elevator 520 can lower the target replacement tray 1324 to the travel position and the shuttle 236 can move to a position below the load receptacle 206. The shuttle elevator 520 can raise the target replacement tray 1324 into position based on the motor encoder.

The tray stacker 402 can secure the target replacement tray 1324 to the load receptacle 206 with the tray lock mechanism 504. After the target replacement tray 1324 has been positioned in the load receptacle 206, the tray stacker 402 can then adjust the position of the target replacement tray 1324 with the tray positioning arms 418 of the load receptacle 206. The tray stacker 402 can then engage the clamp cylinders 502 to actuate the lock fingers 506 of the tray lock mechanism 504 to secure the target replacement tray 1324 against the hard stop bumpers 208 of the load receptacle 206.

Once the target replacement tray 1324 has been secured in the load receptacle 206, the target replacement tray 1324 can serve the same function as the target tray 1320 and be used to receive the electrical components 1212 in later operations. The control flow can then pass back to the process trays step 1308. The control flow continues until there are no more of the source tray 1322 in the input stacker 222.

The swap target tray step 1312 describes moving the target replacement tray 1324 to a temporary holding location, moving the target tray 1320 to the output stacker 234, and then moving the target replacement tray 1324 to the load receptacle 206. However, it is understood that swapping the component trays 202 can be performed in alternate orderings resulting in the swapping of the locations of the target replacement tray 1324 and the target tray 1320.

It has been discovered that the tray stacker system 100 provides improved reliability and flexibility of operation by replacing the source tray 1322 that is empty when the target tray 1320 still have space for additional processed electrical components. Replacing the source tray 1322 on demand allows the tray stacker to uniformly and completely fill the target tray 1320 for use by external systems.

It has been discovered that aligning the component trays 202 with the tray adjust fingers 602 provides improved reliability by positioning the component trays 202 at known locations. More accurate placement of the component trays 202 reduces the number of placement errors for the electrical components.

It has been discovered that shuffling the component trays 202 using the input stacker 222 and the output stacker 234 provides improved speed of operation. By allowing the target tray 1320 that is full to swap positions with the component trays 202 that is empty and in the bottommost position of the output stacker 234, fewer operations are required to load and unload the electrical components on the component trays 202.

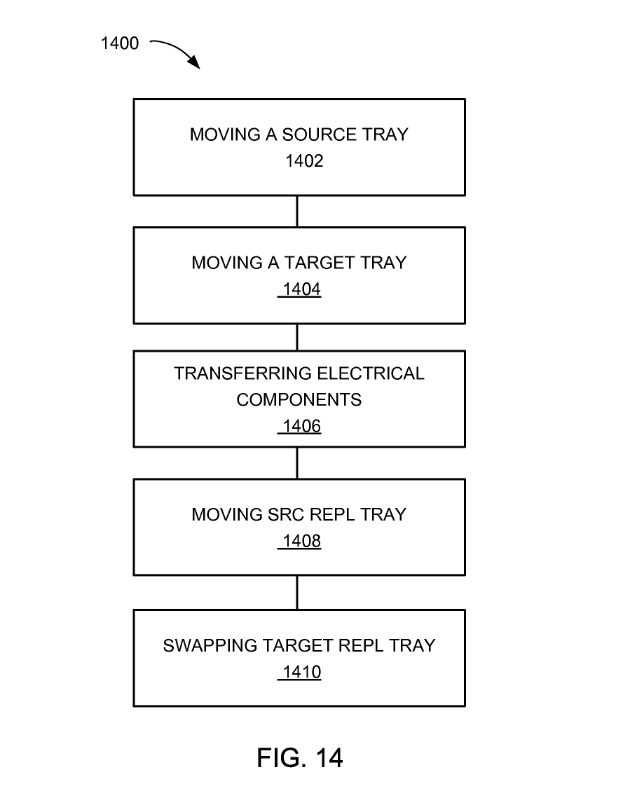

Referring now to FIG. 14, therein is shown a flow chart of a method 1400 of operation of the tray stacker system 100 of FIG. 1 in a further embodiment of the present invention. The method 1400 includes: moving a source tray into an unload receptacle from an input stacker, the source tray for providing a plurality of electrical components in a block 1402; moving a target tray into a load receptacle from an output stacker, the target tray, the target tray for receiving the electrical components from the component tray in the unload receptacle and the target tray empty of the electrical components in a block 1404; transferring the electrical components from the source tray to the target tray in a block 1406; moving a source replacement tray from the input stacker to the unload receptacle for replacing the source tray empty of the electrical components and moving the source tray to the output stacker in a block 1408; and swapping a target replacement tray in the output stacker with the target tray in the load receptacle, the target tray having a plurality of the electrical components in a block 1410.

It has been discovered that the tray stacker system 100 of the present invention furnishes important and heretofore unknown and unavailable solutions, capabilities, and functional aspects for processing the component trays having electrical devices.

The resulting processes and configurations are straightforward, cost-effective, uncomplicated, highly versatile and effective, can be surprisingly and unobviously implemented by adapting known technologies, and are thus readily suited for efficiently and economically manufacturing semiconductor packages fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a tray stacker system comprising:
moving a source tray into an unload receptacle from an input stacker, the source tray for providing a plurality of electrical components;
moving a target tray into a load receptacle from an output stacker, the target tray, the target tray for receiving the electrical components from the component tray in the unload receptacle and the target tray empty of the electrical components;
transferring the electrical components from the source tray to the target tray;
moving a source replacement tray from the input stacker to the unload receptacle for replacing the source tray empty of the electrical components and moving the source tray to the output stacker; and
swapping a target replacement tray in the output stacker with the target tray in the load receptacle, the target tray having a plurality of the electrical components.

2. The method as claimed in claim 1 wherein moving the target tray includes securing the target tray in the load receptacle with a tray lock mechanism.

3. The method as claimed in claim 1 wherein moving the source tray includes removing the source tray from the input stacker.

4. The method as claimed in claim 1 wherein swapping the target replacement tray includes:
moving the target replacement tray from the output stacker to the input stacker, the target replacement tray empty of the electrical components;
moving the target tray from the load receptacle to the output stacker; and
moving the target replacement tray from the input stacker to the load receptacle, the load receptacle empty of the target tray.

5. The method as claimed in claim 1 wherein swapping the target replacement tray to the output stacker includes attaching the target tray to the output stacker with a stacker tray lock.

6. A method of operation of a tray stacker system comprising:
providing a shuttle with a shuttle elevator;
moving a source tray into an unload receptacle from an input stacker with the shuttle and the shuttle elevator, the source tray for providing a plurality of electrical components;
moving a target tray into a load receptacle from an output stacker with the shuttle and the shuttle elevator, the target tray for receiving the electrical components from the component tray in the unload receptacle and the target tray empty of the electrical components;
transferring the electrical components from the source tray to the target tray;
moving a source replacement tray from the input stacker to the unload receptacle for replacing the source tray empty of the electrical components and moving the source tray to the output stacker; and
swapping a target replacement tray in the output stacker with the target tray in the load receptacle, the target tray having a plurality of the electrical components.

7. The method as claimed in claim 6 wherein moving the target tray includes securing the target tray in the load receptacle with a tray lock mechanism having a lock finger actuated by a clamp cylinder.

8. The method as claimed in claim 6 wherein moving the source tray includes removing the source tray from the input stacker with the shuttle having the shuttle elevator for moving the source tray vertically.

9. The method as claimed in claim 6 wherein swapping the target replacement tray includes:
moving the target replacement tray from the output stacker to the input stacker with the shuttle, the target replacement tray empty of the electrical components;
moving the target tray from the load receptacle to the output stacker with the shuttle; and
moving the target replacement tray from the input stacker to the load receptacle with the shuttle, the load receptacle empty of the target tray.

10. The method as claimed in claim 6 wherein swapping the target replacement tray to the output stacker includes attaching the target tray to the output stacker with a stacker tray lock.

11. A tray stacker system comprising:
an input stacker for providing a source tray having a plurality of electrical components;
an unload receptacle for receiving the source tray from the input stacker;
an output stacker for providing the target tray empty of the electrical components;
a load receptacle for receiving the component tray empty of the electrical components from the output stacker; and
wherein:
the unload receptacle is for receiving a source replacement tray from the input stacker, the source replacement tray having a plurality of the electrical components, and
the load receptacle is for swapping the target replacement tray in the output stacker with the target tray in the load receptacle, the target tray having a plurality of the electrical components.

12. The system as claimed in claim 11 further comprising a tray lock mechanism for securing the target tray in the load receptacle.

13. The system as claimed in claim 11 wherein the input stacker is for providing the source tray to the unload receptacle.

14. The system as claimed in claim 11 wherein:
the output stacker is for moving the target replacement tray from the output stacker to the input stacker;
the output stacker is for receiving the target tray from the load receptacle; and
the input stacker is for moving the target replacement tray to the load receptacle.

15. The system as claimed in claim 11 further comprising a stacker tray lock for attaching the target tray to the output stacker.

16. The system as claimed in claim 11 further comprising a shuttle having a shuttle elevator for moving the source tray and the target tray.

17. The system as claimed in claim 16 further comprising:
a tray lock mechanism having a lock finger and a clamp cylinder for securing the source tray to the load receptacle; and
wherein:
the lock finger is for securing the target tray to the load receptacle, and
the clamp cylinder is for actuating the lock finger.

18. The system as claimed in claim 16 wherein the shuttle elevator is for moving the source tray vertically from the input stacker.

19. The system as claimed in claim 16 wherein:
the output stacker is for moving the target replacement tray from the output stacker to the input stacker;
the output stacker is for receiving the target tray from the load receptacle; and
the input stacker is for moving the target replacement tray to the load receptacle.

20. The system as claimed in claim 16 further comprising a stacker tray lock having a lock arm and a stacker lock cylinder for attaching the source tray to the output stacker.
